(19) United States
(12) Patent Application Publication
(10) Pub. No.: US 2019/0276078 A1
(43) Pub. Date: Sep. 12, 2019

(54) TRAILER REVERSE GUIDANCE GRAPHICS

(71) Applicant: GM GLOBAL TECHNOLOGY OPERATIONS LLC, Detroit, MI (US)

(72) Inventors: Sepehr Pourrezaei Khaligh, North York (CA); Akram M. Abdel-Rahman, Ajax (CA)

(21) Appl. No.: 15/915,634

(22) Filed: Mar. 8, 2018

(51) Int. Cl. B62D 15/02; B62D 13/00

(52) U.S. Cl. CPC B62D 15/0295; B62D 13/005

(57) ABSTRACT

A vehicle, system and method for steering a trailer attached to a vehicle via a hitch along a selected path. A display of the vehicle shows a view behind the trailer. A processor projects a predicted path of the trailer and an instantaneous path of the trailer onto the display. The predicted path is affected by a steering angle at the vehicle and a hitch angle and the instantaneous path is affected by the hitch angle. A steering system is used to change the steering angle at the vehicle to adjust the predicted path, wherein an effect of the predicted path on the instantaneous path brings the instantaneous path of the trailer into alignment with the selected path.

The subject disclosure relates to systems and methods for vehicle-assisted driving and, in particular, to a system that aids in directing a trailer or towed load when driving backwards.

When a vehicle tows a trailer and is moving in a forward direction, forces applied to the trailer cooperate to keep the trailer at a known location behind the vehicle. However, when backing up, the vehicle has less control over the trailer since forces applied by the vehicle to the trailer are often off-centered, causing the trailer to move to one side or another of the vehicle. Compensating for this side-to-side motion is generally left up to ability of the driver. Accordingly, it is desirable to provide a system and method that aids the driver to maintain control of the trailer when backing up the vehicle.

### SUMMARY

In one exemplary embodiment, a method of steering a trailer attached to a vehicle via a hitch along a selected path is disclosed. The method includes applying a force from the vehicle to push the trailer via the hitch, projecting a predicted path of the trailer onto the projected view at a display of the vehicle, wherein the predicted path is affected by a steering angle at the vehicle and a hitch angle, projecting an instantaneous path of the trailer onto the display, wherein the instantaneous path is affected by the hitch angle, and steering the vehicle to move a location of the predicted path, wherein an effect of the predicted path on the instantaneous path brings the instantaneous path of the trailer into alignment with the selected path.

In addition to one or more of the features described herein, the method further includes determining the predicted path by determining a predicted hitch angle between the trailer and the vehicle at a selected distance given a current hitch angle and current steering angle. The instantaneous path of the trailer may be determined based on a current hitch angle between the trailer and the vehicle. The camera may be attached at one of a rear end of the trailer, and a side-view mirror of the vehicle. The predicted path of the trailer may be used to provide a visual indication of a jackknife condition. The visual indication may include at least one of reducing a length of the predicted path, making the predicted path flash alternately, and merging the display of the predicted path and the instantaneous path at the display.

In another exemplary embodiment, a system for steering a trailer attached to a vehicle is disclosed. The system includes a hitch between the vehicle and the trailer through which the vehicle pushes the trailer, a display that shows a view behind the trailer, a processor and a steering system. The processor is configured to project a predicted path of the trailer onto the view at the display, wherein the predicted path is affected by a steering angle at the vehicle and a hitch angle, and project an instantaneous path of the trailer onto the display, wherein the instantaneous path is affected by the hitch angle. The steering system is configured to change the steering angle at the vehicle to adjust the predicted path, wherein an effect of the predicted path on the instantaneous path brings the instantaneous path of the trailer into alignment with the selected path.

In addition to one or more of the features described herein, the processor determines the predicted path by calculating a predicted hitch angle between the trailer and the vehicle when the trailer moves a selected distance given a current hitch angle and current steering angle. The processor may determine the instantaneous path based on a current hitch angle. The camera may be attached at one of a rear end of the trailer, and a side-view mirror of the vehicle. The processor may provide a visual indication of a jackknife condition at the display based on the predicted hitch angle. In various embodiments, the visual indication includes at least one of a reduced in length of the predicted path, a flashing of the predicted path, and a merging of the display of the predicted path and the instantaneous path at the display.

In yet another exemplary embodiment, a vehicle is disclosed. The vehicle includes a hitch for attached a trailer to the vehicle and through which the vehicle pushes the trailer, a display configured to display a view behind the trailer, a processor and a steering system. The processor is configured to project a predicted path of the trailer onto the view at the display, wherein the predicted path is affected by a steering angle at the vehicle and a hitch angle, and project an instantaneous path of the trailer onto the display, wherein the instantaneous path is affected by the hitch angle. The steering system configured to change the steering angle at the vehicle to adjust the predicted path, wherein an effect of the predicted path on the instantaneous path brings the instantaneous path of the trailer into alignment with the selected path.

In addition to one or more of the features described herein, the processor determines the predicted path by predicting a hitch angle between the trailer and the vehicle when the mobile element moves a selected distance given a current hitch angle and current steering angle. The processor may determine the instantaneous path based on a current hitch angle. The camera may be attached at one of a rear end of the trailer, and a side-view mirror of the vehicle. The processor may provide a visual indication of a jackknife condition at the display based on a predicted hitch angle. In one embodiment, the visual indication of the jackknife condition uses the predicted path of the trailer. In various embodiments, the processor provides the visual indication as at least one of a reduction in a length of the predicted path, a flashing of the predicted path, and a merging of the predicted path and the instantaneous path at the display.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle towing a trailer in accordance with various embodiments;

FIG. 2 shows a vehicular system that includes the vehicle and the trailer;

FIG. 3 shows a schematic diagram of the system of FIG. 2 with relevant parameters for determining a motion of the trailer;

FIG. 4 shows an illustrative view of the area behind the trailer that is shown at a display of the vehicle; and

FIG. 5 shows an illustrative view of a display indicating a jackknife condition between the trailer and the vehicle.

### DETAILED DESCRIPTION

The following description is merely exemplary in nature and is not intended to limit the present disclosure, its application or uses. It should be understood that throughout the drawings, corresponding reference numerals indicate like or corresponding parts and features.

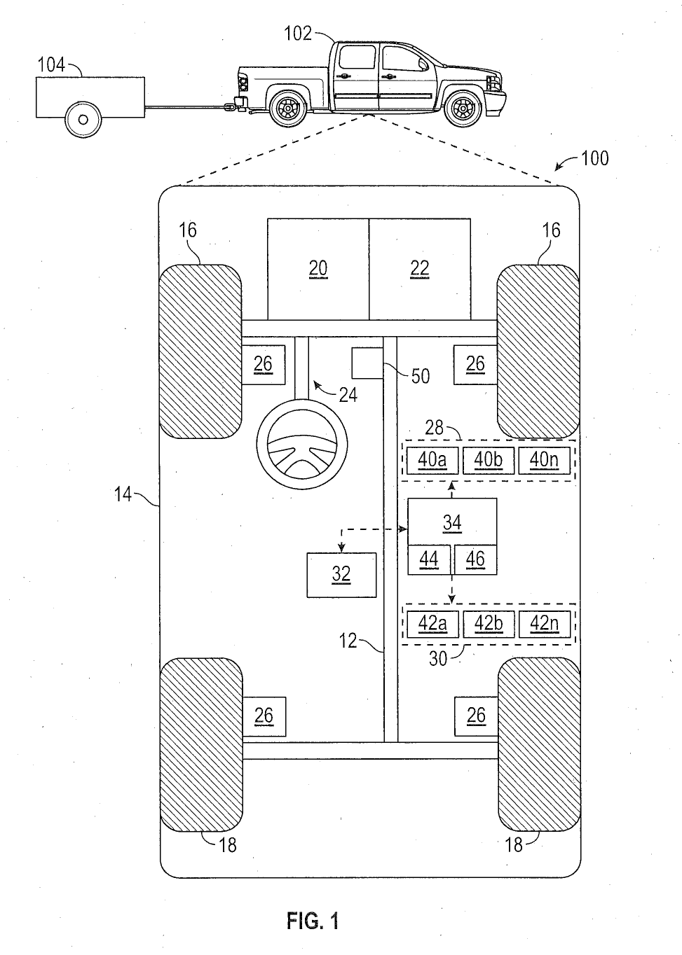

In accordance with an exemplary embodiment, FIG. 1 shows a vehicle 102 towing a trailer 104 in accordance with various embodiments. The vehicle 102 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16 and 18 are each rotationally coupled to the chassis 12 near a respective corner of the body 14. The trailer 104 is generally connected to the vehicle 102 by a rigid connection.

In various embodiments, the vehicle 102 can be a non-autonomous vehicle that responds directly to a driver's input or command. In other embodiments, the vehicle 102 is an autonomous vehicle including a trajectory planning system 100 incorporated therein that determines a trajectory plan for automated driving of the vehicle 102. An autonomous vehicle can be, for example, a vehicle that is automatically controlled to carry passengers from one location to another. In various embodiments, the autonomous vehicle can be a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. The vehicle 102 is depicted in the illustrated embodiment as a truck, but it should be appreciated that any other vehicle including passenger vehicles, sport utility vehicles (SUVs), recreational vehicles (RVs), etc., can also be used.

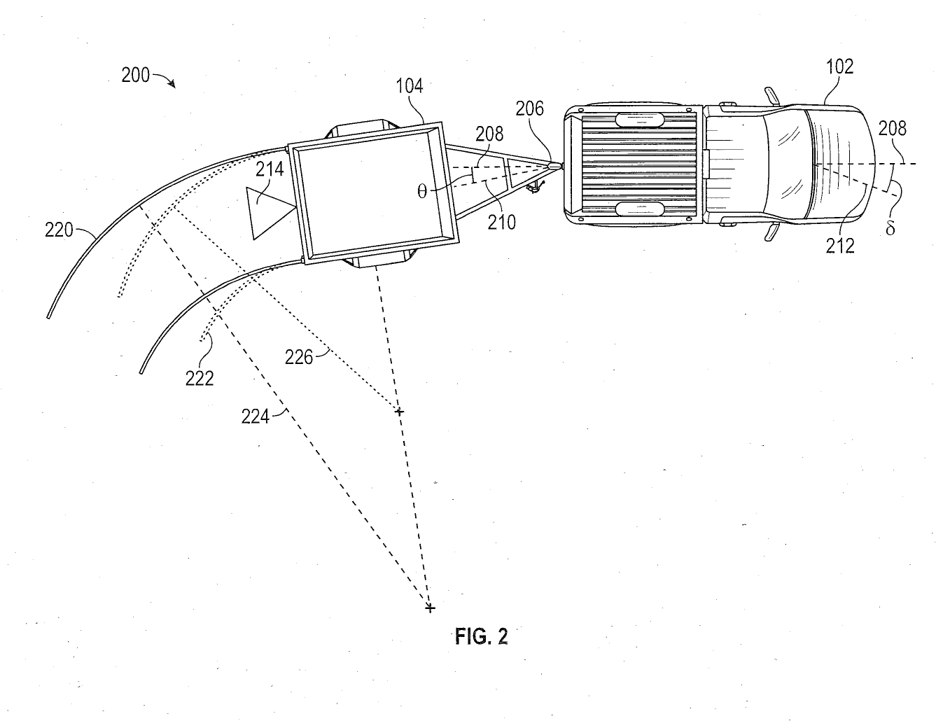

As shown, the vehicle 102 generally includes a propulsion system 20, a transmission system 22, a steering system 24 (such as a steering wheel), a brake system 26, a sensor system 28, an actuator system 30, at least one data storage device 32 and at least one controller. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16 and 18. The brake system 26 may, in various embodiments, include friction brakes, brake by wire, a regenerative braking system such as an electric machine, and/or other appropriate braking systems. The steering system 24 influences a direction (212, FIG. 2) or angle δ of the vehicle wheels 16 and 18.

The vehicle 102 can include a sensor system 28 that includes one or more sensing devices 40a-40n that sense observable conditions of the exterior environment and/or the interior environment of the vehicle 102. The sensing devices 40a-40n can include, but are not limited to, cameras, digital cameras, video cameras, etc., located at several locations of the vehicle 102 or of the trailer 104. The actuator system 30 includes one or more actuator devices 42a-42n that control one or more vehicle features such as, but not limited to, the propulsion system 20, the transmission system 22, the steering system 24, and the brake system 26. In various embodiments, features of the vehicle 102 can further include interior and/or exterior vehicle features such as, but are not limited to, doors, a trunk, and cabin features such as air, music, lighting, etc. (not numbered).

The controller 34 of vehicle 102 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 102.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle, and generate control signals to the actuator system 30 to automatically control the components of the autonomous vehicle based on the logic, calculations, methods, and/or algorithms. Although only one controller 34 is shown in FIG. 1, embodiments of the autonomous vehicle can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle. In various embodiments, the processor 44 controls the actuator devices 42a-42n to move the vehicle 102 along a calculated path in order to control motion of the trailer 104 to a selected location.

The vehicle 102 can also include a display 50 that shows images obtained by the various sensors 40a-40n, in particular, by cameras. The display 50 can also project or overlay path guidelines resulting from various calculations made with respect to the vehicle 10 in order to allow the driver to maneuver the trailer 104, based on the visual cues provided by the guidelines, as discussed below. The results of the various calculations can include a predicted path of the trailer 104 and an instantaneous path of the trailer 104.

FIG. 2 shows a vehicular system 200 that includes the vehicle 102 and the trailer 104. The trailer 104 receives its motive force from the vehicle 102. The trailer 104 is attached to the vehicle 102 at a hitch 206 located at a back of the vehicle 102. In alternate embodiments, the trailer 104 can be attached at a front end of the vehicle. The hitch 206 is generally located along a longitudinal axis 208 of the vehicle 102. A hitch angle θ defines an angle between the longitudinal axis 208 of the vehicle 102 and a longitudinal axis 210 of the trailer 104, which generally intersect at the hitch 206. The hitch 206 can include a sensor that measures the hitch angle θ and provides the hitch angle θ to the processor (44, FIG. 1). When the vehicle 102 is backing up, due to the unstable configuration of vehicle 102 and trailer 104, the pushing force applied to the trailer 104 by the vehicle 102 through the hitch 206 generally causes the trailer 104 to divert to one side or another.

The system 200 disclosed herein provides a method of controlling the motion of the trailer 104 as the vehicle 102 is backing up. The system 200 includes a camera 214 that captures an image of the area behind the trailer. As shown in FIG. 2, the camera 214 is located at a rear of the trailer 204. In alternate embodiments, the camera 214 can be located at a side mirror of the vehicle 102 or on a roof of the trailer 104, for example. In various embodiments, the camera 214 is a permanent fixture in the trailer 104 or in the vehicle 102. The captured image can be transmitted to the processor (44, FIG. 1) of the vehicle 102. The processor (44, FIG. 1) performs calculations for controlling motion of the trailer while the vehicle 102 is backing up, as discussed below.

FIG. 2 shows a first path 220 indicating an instantaneous path of the trailer 104 based on a selected hitch angle θ between the trailer 104 and the vehicle 102. A second path 222 represents a predicted path of the trailer 104 based on the hitch angle θ and a steering angle δ of the vehicle 102. Line 224 represents a radius of curvature of the first path 220 and line 226 represents a radius of curvature of the second path 222.

In various embodiment, the processor (44, FIG. 1) performs calculations to determine the second path 222, i.e., to predict the path of the trailer 104 based on the alignment of forces. Calculations include various dimensions of the vehicle 102 and of the trailer 104 and various angles of the vehicle 102 and trailer 104. In particular, the calculations determine a predicted hitch angle θ_{d} at a selected distance d from the current location of the trailer 204, as shown in Eqs. (1)-(4):

$${θ}_{d} = 2 {tan}^{- 1} ( \frac{{y}_{3} tan ( \frac{{y}_{1} - {y}_{2}}{2 {l}_{tr} {l}_{w}} ) - {l}_{w} cos ( δ )}{( {l}_{tr} - {l}_{h} ) sin ( δ )} ) \qquad Eq . ( 1 )$$

where

$$\begin{matrix}{y}_{1} = 2 {l}_{tr} {l}_{w} ( \frac{{l}_{w} cos ( δ ) + ( {l}_{tr} - {l}_{h} ) tan ( \frac{θ}{2} ) sin ( δ )}{cos ( δ ) \sqrt{( {l}_{tr}^{2} - {l}_{h}^{2} ) {( tan ( δ ) )}^{2} - {l}_{w}^{2}}} ) & Eq . ( 2 ) \\ {y}_{2} = - d \sqrt{( {l}_{tr}^{2} - {l}_{h}^{2} ) {( tan ( δ ) )}^{2} - {l}_{w}^{2}} & Eq . ( 3 ) \\ {y}_{3} = cos ( δ ) \sqrt{( {l}_{tr}^{2} - {l}_{h}^{2} ) {( tan ( δ ) )}^{2} - {l}_{w}^{2}} & Eq . ( 4 )\end{matrix}$$

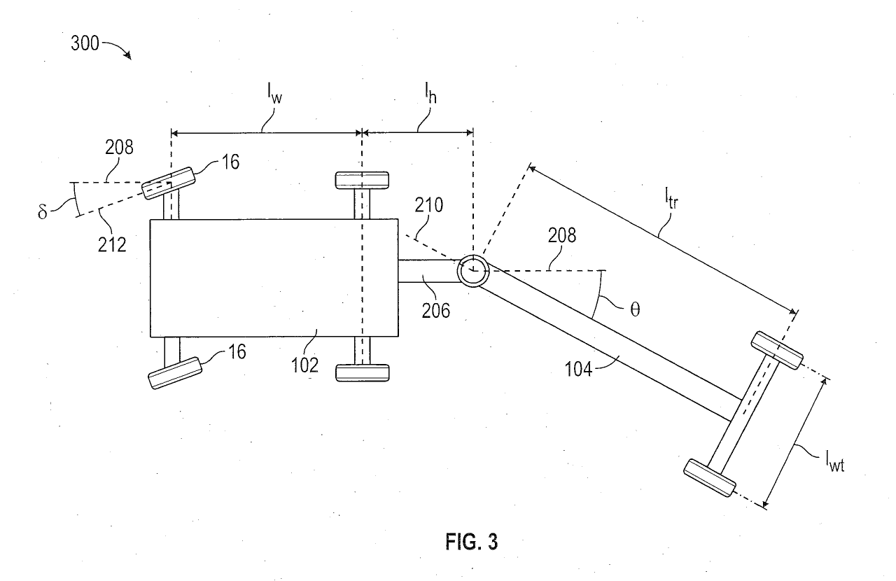

The parameters of Eqs. (1)-(4) as illustrated in the schematic diagram 300 of the vehicle-trailer configuration shown in FIG. 3. Parameter l_{w} is a length of a wheel base of the vehicle 102, lₕ is a length of a hitch, lₜᵣ is a length of the trailer 104 and l_{wt} is a width of the trailer 104. Angle θ is a hitch angle between the longitudinal axis 208 of the vehicle 102 and the longitudinal axis 210 of the trailer 104 at the hitch 206. Angle δ is a steering angle of the vehicle 102 or, in other words, an angle between the longitudinal axis 208 of the vehicle 102 and a direction 212 of the front wheels 16 of the vehicle 102.

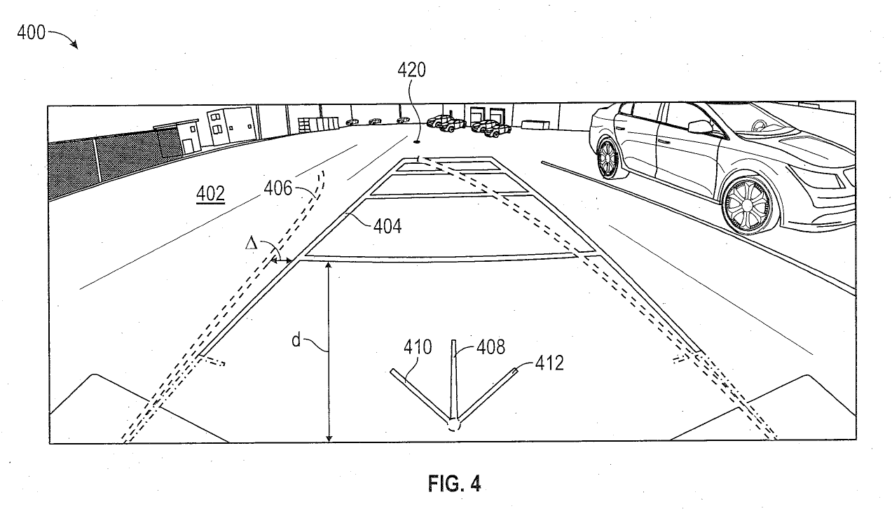

FIG. 4 shows an illustrative view 400 of the area 402 behind the trailer that is captured by a camera (214, FIG. 2) and shown at a suitable display, such as at display (50, FIG. 1) of the vehicle 102. In one embodiment, a driver can use the lines drawn across the surface shown in the display in order to control motion of the trailer. The view 400 includes a first pair of guidelines 404 overlaid over the area, the first pair of guidelines 404 representing an instantaneous path of the trailer based on the current hitch angle θ. A second pair of guidelines 406 is also shown and represents a predicted path of the trailer based on the current hitch angle θ and current steering angle δ as calculated by Eqs. (1)-(4). The first pair of guidelines 404 and the second pair of guidelines 406 can be visually distinguished at the display by a suitable marking, such as by different colors, different formats (dotted vs. solid), etc. Also shown for illustrative purposes is a selected location or destination 420 for the trailer which is reachable by a selected path that is not currently aligned with the instantaneous path. A distance d from the rear of the trailer is shown of illustrative purposes. The first pair of guidelines 404 and second pair of guidelines 406 are separated by an amount Δ at distance d. As the trailer moves backward (reducing d), the first pair of guidelines 404 (i.e., the instantaneous path) tends to adjust itself to align with the second pair of guidelines 406 (i.e., the predicted path). Using the steering wheel and the guidelines at the display, the driver can change steering angle δ to adjust the second pair of guidelines path 406, thereby causing the first pair of guidelines 404 to change due to its tendency to align itself with the second pair of guidelines 406 during back-up. The driver (via the steering wheel) changes the second pair of guidelines 406 in order to bring the first pair of guidelines 404 (which is continually aligning along the second pair of guidelines 406) along the selected or desired path for the trailer 104 to reach the selected destination 420. The first pair of guidelines 404 and second pair of guidelines 406 therefore instruct the driver on a selected steering angle that backs the trailer 104 into the desired location or destination 420.

Also shown in FIG. 4 is a hitch angle θ indicator 408 of the vehicle 102. The hitch angle indicator 408 may corresponding to a hitch angle measured by a sensor at the hitch 206. The hitch angle θ is indicated by hitch angle indicator 408 which is angularly bound by hitch angle limits 410 and 412. While the hitch angle indicator 408 is between these hitch angle limits 410 and 412, the trailer is in a controllable angular position with respect to the vehicle. However, when the hitch angle indicator 408 meets these hitch angle limits 410 and 412, the trailer and the vehicle find themselves in a jackknife condition in which control of the trailer is diminished or lost.

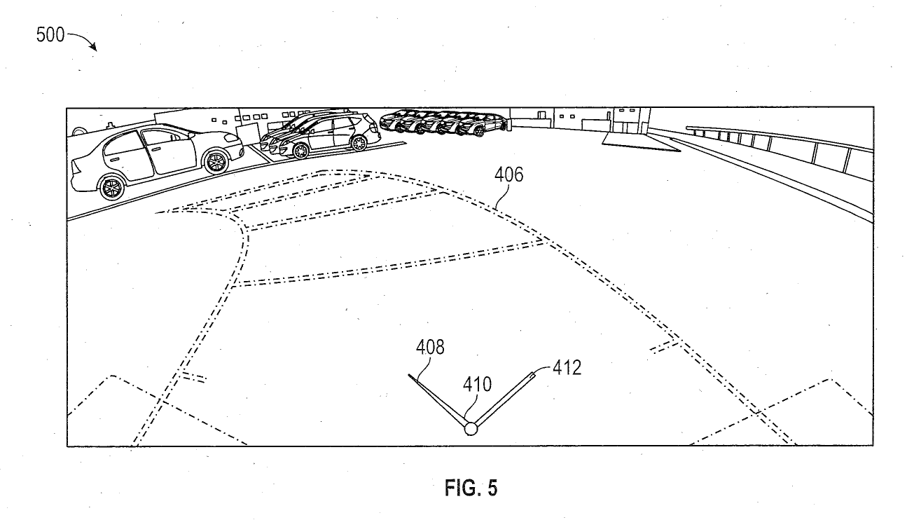

FIG. 5 shows an illustrative view 500 of a display indicating a jackknife condition between the trailer 104 and the vehicle 102. The hitch angle indicator 408 is up against the left hitch angle limit 410. In order to indicate a jackknife condition, the display shows the instantaneous path with a different marking than when not in a jackknife condition, for example, by change the color to red, flashing the predicted path on the screen, or cropping or shortening the guideline predicted path at the screen to indicate a warning. In one embodiment, the display shows warning signals for various warning stages to warn the driver of a jackknife condition in order that such conditions can be avoided.

A first warning stage occurs when the predicted hitch angle θ_{d} is equal to a jackknife angle, (i.e., θ_{d}=θⱼₖ). At the first warning stage, the second pair of guidelines 406 (related to the predicted path) is displayed at the jackknife angle. However, none of the second pair of guidelines 406 is cropped.

A second warning stage occurs when the predicted hitch angle exceeds the jackknife angle (i.e., θⱼₖ<θ_{d}<(115%)*θⱼₖ). At the second warning stage, the second pair of guidelines 406 is displayed at the jackknife angle and a length of the second pair of guidelines 406 is reduced or cropped by up to a selected crop limit. In various embodiments, the crop limit is about 2 meters. Cropping generally refers to reducing or removing the portion of the guidelines that is farthest from the trailer. However, it is to be understood that the crop limit can be any desired amount. The actual amount of the reduction is in linear proportion to the degree that the predicted hitch angle exceeds the jackknife angle, with the reduction being 0 meters when the hitch angle equals the jackknife angle and the reduction being 2 meters (or the crop limit) when the predicted hitch angle is equal to 115% of jackknife angle.

A third warning stage occurs when the predicted hitch angle exceeds 115% of the jackknife angle and the current hitch angle is less than the jackknife angle (i.e., θ_{d}>(115%)*θⱼₖ and θ_{current}<θⱼₖ). At the third warning stage, the second pair of guidelines 406 is displayed at the jackknife angle and is cropped at the crop limit. In addition, the second pair of guidelines 406 will flash at a selected flash rate, such as at 2 Hz.

A fourth warning stage occurs when the predicted hitch angle exceeds 115% of the jackknife angle and the current hitch angle is greater than or equal to the jackknife angle (i.e., θ_{d}>(115%)*θⱼₖ and θ_{current}>=θⱼₖ). At the fourth warning stage, the second pair of guidelines 406 is merged with the first pair of guidelines 404 and turned into a solid red line that is the length of the first pair of guidelines 404. In other words, no cropping takes place. In addition, no flashing occurs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of steering a trailer attached to a vehicle via a hitch along a selected path, comprising:
applying a force from the vehicle to push the trailer via the hitch;
projecting a predicted path of the trailer onto the projected view at a display of the vehicle, wherein the predicted path is affected by a steering angle at the vehicle and a hitch angle; and
projecting an instantaneous path of the trailer onto the display, wherein the instantaneous path is affected by the hitch angle, wherein a difference between the predicted path and the instantaneous path indicates a steering adjustment for moving the trailer along the selected path.

2. The method of claim 1, further comprising determining the predicted path by determining a predicted hitch angle between the trailer and the vehicle at a selected distance given a current hitch angle and current steering angle.

3. The method of claim 1, further comprising determining the instantaneous path of the trailer based on a current hitch angle between the trailer and the vehicle.

4. The method of claim 1, further comprising steering the vehicle according to the indicated steering adjustment in order to move trailer into alignment with the selected path.

5. The method of claim 1, further comprising providing a visual indication of a jackknife condition using the predicted path of the trailer.

6. The method of claim 1, wherein the visual indication includes at least one of: (i) reducing a length of the predicted path; (ii) making the predicted path flash alternately; and (iii) merging the display of the predicted path and the instantaneous path at the display.

7. A system for steering a trailer attached to a vehicle, comprising:
a hitch between the vehicle and the trailer through which the vehicle pushes the trailer;
a display that shows a view behind the trailer; and
a processor configured to:
project a predicted path of the trailer onto the view at the display, wherein the predicted path is affected by a steering angle at the vehicle and a hitch angle, and
project an instantaneous path of the trailer onto the display, wherein the instantaneous path is affected by the hitch angle, wherein a difference between the predicted path and the instantaneous path indicates a steering adjustment for moving the trailer along the selected path.

8. The system of claim 7, wherein the processor is further configured to determine the predicted path by calculating a predicted hitch angle between the trailer and the vehicle when the trailer moves a selected distance given a current hitch angle and current steering angle.

9. The system of claim 7, wherein the processor is further configured to determine the instantaneous path based on a current hitch angle.

11. The system of claim 7, further comprising a steering system configured to change the steering angle at the vehicle according to the indicated steering adjustment in order to move trailer into alignment with the selected path.

12. The system of claim 11, wherein the processor is further configured to provide a visual indication of a jackknife condition at the display based on the predicted hitch angle.

13. The system of claim 12, wherein the processor is further configured to provide the visual indication that is at least one of: (i) a reduced in length of the predicted path; (ii) a flashing of the predicted path; and (iii) a merging of the display of the predicted path and the instantaneous path at the display.

14. A vehicle, comprising:
a hitch for attaching a trailer to the vehicle and through which the vehicle pushes the trailer;
a display configured to display a view behind the trailer; and
a processor configured to:
project a predicted path of the trailer onto the view at the display, wherein the predicted path is affected by a steering angle at the vehicle and a hitch angle, and
project an instantaneous path of the trailer onto the display, wherein the instantaneous path is affected by the hitch angle, wherein a difference between the predicted path and the instantaneous path indicates a steering adjustment for moving the trailer along the selected path.

15. The vehicle of claim 14, wherein the processor is further configured to determine the predicted path by predicting a hitch angle between the trailer and the vehicle when the mobile element moves a selected distance given a current hitch angle and current steering angle.

16. The vehicle of claim 14, wherein the processor is further configured to determine the instantaneous path based on a current hitch angle.

17. The vehicle of claim 14, further comprising a steering system configured to change the steering angle at the vehicle according to the indicated steering adjustment in order to move trailer into alignment with the selected path.

18. The vehicle of claim 14, wherein the processor is further configured to provide a visual indication of a jackknife condition at the display based on a predicted hitch angle.

19. The vehicle of claim 14, wherein the processor is further configured to provide a visual indication of a jackknife condition using the predicted path of the trailer.

20. The vehicle of claim 18, wherein the processor is further configured to provide the visual indication that is at least one of: (i) a reduction in a length of the predicted path; (ii) a flashing of the predicted path; and (iii) a merging of the predicted path and the instantaneous path at the display.
